(19) United States
(12) Patent Application Publication
(10) Pub. No.: US 2022/0298830 A1
(43) Pub. Date: Sep. 22, 2022

(54) MULTI-CLASS LINKED LOCK, AND CASE APPLYING THE SAME

(71) Applicant: Merit Technologies (Fujian) Co., Ltd., Quanzhou (CN)

(72) Inventors: Yishun Hou, Quanzhou (CN); Qun Yu, Quanzhou (CN)

(21) Appl. No.: 17/806,472

(22) Filed: Jun. 10, 2022

Related U.S. Application Data
(63) Continuation-in-part of application No. PCT/CN2020/132564, filed on Nov. 30, 2020.

(30) Foreign Application Priority Data
Dec. 5, 2019 (CN) 201911232244.1

(51) Int. Cl. E05B 65/52; E05B 63/14; A45C 5/03; A45C 13/10

(52) U.S. Cl. CPC E05B 65/5261; E05B 63/14; A45C 5/03; A45C 13/10

(57) ABSTRACT

Disclosed is a novel multi-class interlock. The interlock includes a main lock and a pair of main lock hooks adapted for the main lock. The main lock includes a main lock housing, a control mechanism, and a pair of main lock cylinder assemblies. The main lock cylinder assemblies and the control mechanism both are arranged within the main lock housing. The pair of main lock assemblies are located at both sides of the control mechanism, respectively. The control mechanism is capable of controlling the locking and unlocking of all of the main lock cylinder assemblies. The main lock hooks are provided with a plurality of first protruding teeth adapted for the main lock cylinder assemblies. The present invention provides a multi-class interlock which uses multiple-class interlocking to realize easy closing for the case.

### CROSS REFERENCE OF RELATED APPLICATIONS

This application is a continuation in part of PCT Patent Application No. PCT/CN2020/132564, filed Nov. 30, 2020, entitled “NOVEL MULTI-STAGE LINKED LOCK, AND CASE APPLYING THE SAME,” which claims foreign priority of Chinese Patent Application No. 201911232244.1, filed Dec. 5, 2019 in the China National Intellectual Property Administration (CNIPA), the entire contents of which are hereby incorporated by reference in their entireties.

### FIELD OF THE DISCLOSURE

The invention relates to a lock, especially to a novel multi-stage linked lock and case applying the same.

### BACKGROUND OF THE DISCLOSURE

A suitcase is a container which holds a traveler's articles when people go outing. In order to keep the articles inside the case safe, locks are commonly used by people on the suitcases. However, during packing up, it requires quite a force to press conventional single stage locks or single-stage interlocks to lock the suitcases, which is very inconvenient to use.

Accordingly, it is an urgent problem for those skilled in the art to provide a multi-stage interlock that can be easily locked.

### SUMMARY OF THE DISCLOSURE

The object of the present invention is to provide a novel multi-stage interlock, solving the problem that it requires quite a force for the conventional single stage locks or single-stage interlocks to be pressed for locking.

In order to solve the above technical problems, the present invention provides the following technical solutions: a novel multi-stage interlock, including a main lock and a pair of main lock hooks matched with the main lock. The main lock includes a main lock housing, a control mechanism and a pair of main lock cylinder assemblies. The main lock cylinder assemblies and the control mechanism are both arranged in the main lock housing. A pair of main lock cylinder assemblies are located on both sides of the control mechanism. The control mechanism can control the locking and unlocking of all the main lock cylinder assemblies synchronously. The main lock hook is provided with a plurality of first protruding teeth matched with the main lock cylinder assemblies.

Further, the control mechanism includes a customs lock and a drive assembly. The customs lock is arranged on an inner side of the lock cover of the main lock housing. The drive assembly is disposed within the main lock housing.

Furthermore, the drive assembly includes a pusher, at least one reduction gear, a first rack and a second rack. The pusher is slidably arranged in the main lock housing. A push button of the pusher protrudes from a through hole of the lock cover and is slidably matched with the through hole. An upper part of the pusher is connected with a top plate part. A bottom of the top plate part is provided with a rack portion. The rack portion is engaged with a bull gear of the reduction gear. The first rack and the second rack are both slidably arranged in the main lock housing. In addition, the first rack and the second rack are engaged with the pinion gear of the reduction gear. An end of the first rack is connected to a main lock cylinder assembly. An end of the second rack is connected to another main lock cylinder assembly.

Furthermore, the main lock cylinder assembly includes a first button, a first gear and a first spring. The first gear is rotatably arranged in the main lock housing. In addition, the first gear can be engaged with the plurality of first protruding teeth on the corresponding main lock hook. The first button is rotatably arranged in the main lock housing. A first notch is provided on a side of one end of the first button adjacent to the first gear. The other end of the first button is movably connected to the first rack or the second rack. One end of the first spring is connected to the other end of the first button. Under the action of the first spring, the first notch can be snap-connected to the teeth of the first gear.

Furthermore, the main lock also includes a ball plunger and a ball plunger spring. The ball plunger is movably arranged in the main lock housing. The ball plunger spring is arranged between the ball plunger and the main lock housing, and the ball plunger spring biases the ball plunger against the pusher. The pusher is provided with a first indication hole and a second indication hole which are matched with the ball plunger.

Furthermore, when the customs lock is locked, a pressing piece of the customs lock is pressed down against a tail surface of the pusher.

Furthermore, it also includes several side locks and side lock hooks matched with the side locks in one-to-one correspondence. The side lock hook is provided with a plurality of second protruding teeth. The control mechanism can simultaneously control the locking and unlocking of several side locks while controlling the locking and unlocking of the main lock cylinder assembly.

Furthermore, the side lock includes a side lock housing and a side lock cylinder assembly disposed in the side lock housing. The side lock cylinder assembly includes a second button, a second gear and a second spring. The second gear is rotatably arranged in the side lock housing, and the second gear can be engaged with a plurality of protruding teeth on the side lock hook. The second button is rotatably arranged in the side lock housing. One end of the second button is provided with a second notch on one side adjacent to the second gear, and the other end of the second button is connected to the control mechanism through a cable. The second spring is arranged between the second button and the side lock housing. Under the action of the second spring, the second notch can be snap-connected to the teeth of the second gear.

Furthermore, the interlock further includes a plurality of side locks and side lock hooks adapted for the side locks in one-to-one correspondence. The control mechanism is capable of synchronously controlling the locking and unlocking of the main lock cylinder assemblies, and the locking and unlocking of the plurality of side locks. The side lock includes a side lock housing and side lock cylinder assembly arranged within the side lock housing. The side lock cylinder assembly includes a second button and a second spring. The second button is rotatably arranged within the side lock housing. One end of the second button is provided with a clamp hook on a side adjacent to the side lock hook, and the other end of the second button is connected to the control mechanism through a cable. The second spring is arranged between the second button and the side lock housing. Under the action of the second spring, the clamp hook is capable of being snap-connected to the side lock hook.

Furthermore, the cable includes an outer sleeve and a core rope. The outer sleeve is fitted over the core rope. One end of the core rope extending out from the outer sleeve is connected to the second button, and the other end of the core rope extending out from the outer sleeve is connected to the control mechanism or another second button.

Another object of the present invention is to provide a case including an upper case body, a lower case body and the above-mentioned novel multi-stage interlock. The upper case body and the lower case body are locked by the novel multi-stage interlock.

As can be seen from the above technical solutions, the present invention has the following beneficial effects.

The present invention adopts multi-stage interlocking, which can be easily. The reduction gear is used for push and pull to reduce the force of the pushing the buttons, bringing a relative ease experience to the user.

There is a spring force that produces audible feedback when unlocking. Users can clearly know whether the suitcase is closed, giving users a better sense of experience.

In the structure of the present invention, appropriate number of locks can be used based on the size of the luggage to ensure the product can be tightly shut, realizing the modularization of the product, making the production and assembly more convenient. The commonality of the product is strong, and some of die sinking of the product and manufacturing cost can be reduced.

The present invention will be further described in detail below with reference to the accompanying drawings and specific embodiments.

### BRIEF DESCRIPTION OF DRAWINGS

In order to illustrate the embodiments of the present invention or the technical solutions in the prior art more clearly, the following briefly introduces the accompanying drawings that are used in the description of the embodiments or the prior art. Obviously, the drawings in the following description are only It is an embodiment of the present invention. For those of ordinary skill in the art, other drawings can also be obtained according to the provided drawings without creative efforts.

FIG. 1 is a three-dimensional schematic diagram of the present invention.

FIG. 2 is an exploded view of the present invention.

FIG. 3 is a schematic diagram of the present invention when being in the locked state.

FIG. 4 is an exploded view of the present invention when being in the locked state.

FIG. 5 is a partial enlarged schematic diagram of FIG. 3.

FIG. 6 is a partial enlarged structural representation of FIG. 4.

FIG. 7 is a schematic diagram of the present invention when being in unlocked state.

FIG. 8 is an exploded view of the present invention when being in unlocked state.

FIG. 9 is a schematic diagram of the present invention with the side lock removed.

FIG. 10 is a schematic diagram of the present invention with the side lock removed when being in the locked state.

FIG. 11 is an exploded view of the present invention with the side lock removed when being in the locked state.

FIG. 12 is a schematic diagram of the present invention with the side lock removed when being in unlocked state.

FIG. 13 is an exploded view of the present invention with the side lock removed when being in unlocked state.

FIG. 14 is a schematic diagram of the side lock and the side lock hook in the second embodiment of the present invention.

Reference characters in the drawings: main lock 10; main lock hook 20; first protruding teeth 201; side lock 30; side lock hook 40; protruding teeth 401; main lock housing 1; lock base 11; first connection base 111; lock cover 12; through hole 121; first pressing cover 13; second pressing cover 14; main lock cylinder assembly 2; first button 21; first notch 211; first counterface 212; second counterface 213; first gear 22; first spring 23; control mechanism 3; pusher 31; push button 311; rack portion 312; tail surface 313; first indication hole 314; second indication hole 315; reduction gear 32; bull gear 321; pinion gear 322; first rack 33; second rack 34; ball plunger 35; ball plunger spring 36; customs lock 37; pressing plate 371; cable 38; outer sleeve 381; core rope 382; bowl base 39; side lock housing 4; first side pressing cover 41; second side pressing cover 42; second connection base 421; side lock cylinder assembly 5; second button 51; second notch 511; third counterface 512; fourth counterface 513; second gear 52; second spring 53.

### DETAILED DESCRIPTION OF THE DISCLOSURE

The embodiments of the present invention are described in detail below with reference to the accompanying drawings, but the present invention can be implemented in many different ways as defined and covered by the claims.

### First Embodiment

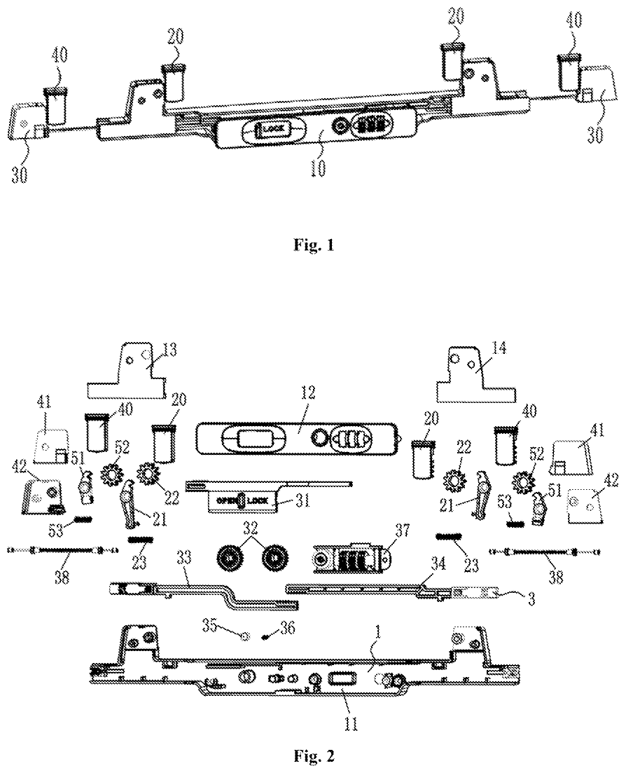

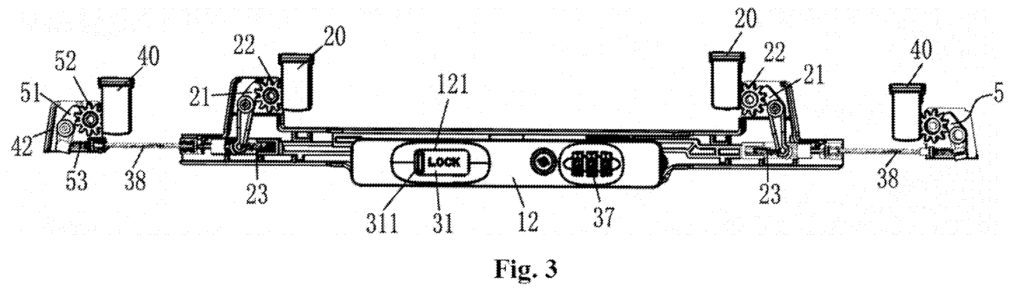

The present invention is further described below with reference to FIG. 1 to FIG. 13. As shown in FIG. 1, FIG. 2, and FIG. 3, a novel multi-stage interlock includes a main lock 10, a pair of main lock hooks 20 matched with the main lock, a pair of side locks 30, and a pair of side lock hooks 40 corresponding one-to-one to the side locks 30. The main lock 10 includes a main lock housing 1, a control mechanism 3 and a pair of main lock cylinder assemblies 2. The main lock housing 1 includes a lock base 11, and a lock cover 12, a first pressing cover 13, and a second pressing cover 14 connected to the lock base 11. The first pressing cover 13 and the second pressing cover 14 are located at both sides of the lock cover 12, respectively. The main lock cylinder assemblies 2 and the control mechanism 3 are both arranged in the main lock housing 1. The pair of main lock cylinder assemblies 2 are located on both sides of the control mechanism, respectively. One of the pair of main lock cylinder assemblies 2 is arranged between the first pressing cover 13 and the lock base 11, and the other one is arranged between the second pressing cover 14 and the lock base 11. Each of the main lock hooks 20 is provided with a plurality of first protruding teeth 201 adapted for the main lock cylinder assemblies 2. Each of the side lock hooks 40 is provided with a plurality of second protruding teeth 401. The control mechanism 3 is capable of controlling the locking and unlocking of the pair of main lock cylinder assemblies 2 and the locking and unlocking of the pair of side locks 30, synchronously.

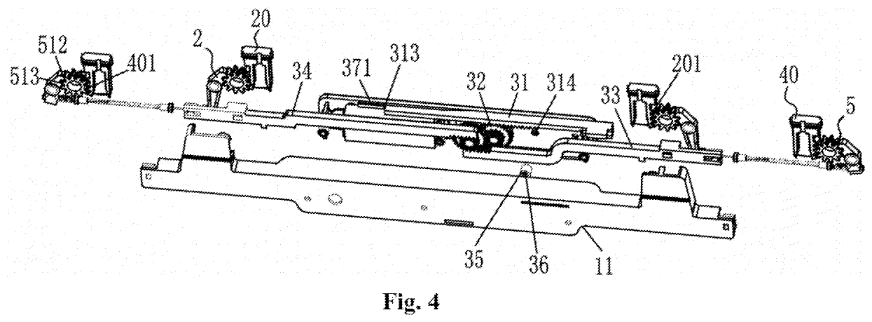

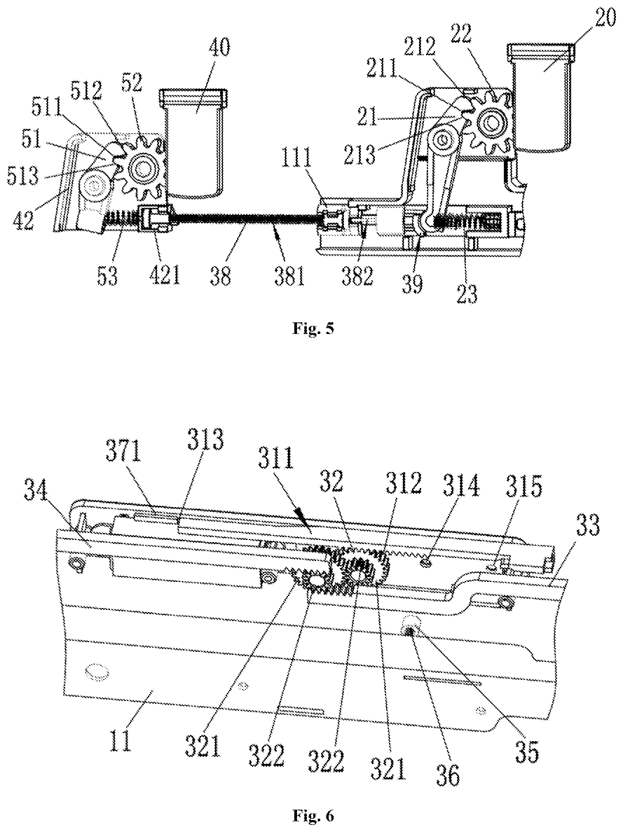

As shown in FIG. 2, FIG. 3, FIG. 4, FIG. 5, and FIG. 6, the control mechanism 3 includes a customs lock 37 and a drive assembly. The customs lock 37 is arranged on an inner side of the lock cover 12 of the main lock housing 1. The drive assembly is disposed within the main lock housing 1. The drive assembly includes a pusher 31, a pair of reduction gears 32, a first rack 33 and a second rack 34. The pusher 31 is slidably arranged in the main lock housing 1. A push button 311 of the pusher 31 protrudes from a through hole 121 of the lock cover 12 and is slidably matched with the through hole 121. An upper part of the pusher 31 is connected with a top plate part 311. A bottom of the top plate part 311 is provided with a rack portion 312. The rack portion 312 is engaged with a bull gear 321 of one of the reduction gear 32. The pinion gear 322 of the reduction gear 32 is engaged with a bull gear 321 of the other one of the reduction gear 32. The pinion gear 322 of the other one of the reduction gear 32 is further engaged with the first rack 33 and the second rack 34, and the first rack 33 and the second rack 34 are both slidably arranged within the main lock housing 1. An end of the first rack 33 is connected to one of the main lock cylinder assemblies 2. An end of the second rack 34 is connected to the other one of the main lock cylinder assemblies 2.

As shown in FIG. 2, FIG. 3, and FIG. 5, the main lock cylinder assembly 2 includes a first button 21, a first gear 22 and a first spring 23. The first gear 22 is rotatably arranged in the main lock housing 1. In addition, the first gear 22 can be engaged with the plurality of first protruding teeth 201 on the corresponding main lock hook 20. The first button 21 is rotatably arranged in the main lock housing 1. A first notch 211 is provided on a side of one end of the first button 21 adjacent to the first gear 22. The other end of the first button 21 is movably connected to the first rack 33 or the second rack 34. One end of the first spring 23 is connected to the other end of the first button 21, while the other end of the first spring 23 is abutted against the first rack 33 or the second rack 34. The first spring 23 biases the other end of the first button 21 against a bowl base 39 of the first rack 33 or the second rack 34. Under the action of the first spring 21, the first notch 211 can be snap-connected to the teeth of the first gear 22.

As shown in FIG. 2, FIG. 4 and FIG. 5, each of the side lock 30 includes a side lock housing 4 and a side lock cylinder assembly 5 arranged within the side lock housing 4. The side lock housing 4 includes a first side pressing cover 41, and a second side pressing cover 42 connected to the first side pressing cover 41. The side lock cylinder assembly 5 includes a second button 51, a second gear, and a second spring 53. The second gear 52 is rotatably arranged on the second side pressing cover 42, and the second gear 52 is capable of engaging with the plurality of second protruding teeth 401 on the side lock hook 40. The second button 51 is rotatably arranged on the second side pressing cover 42. One end of the second button 51 is provided with a second notch 511 on one side adjacent to the second gear 52, and the other end of the second button 51 is connected to the first rack 33 or the second rack 34 through a cable 38. The second spring 53 is arranged between the second button 51 and the side lock housing 4. Under the action of the second spring 53, the second notch 511 can be snap-connected to the teeth of the second gear 52.

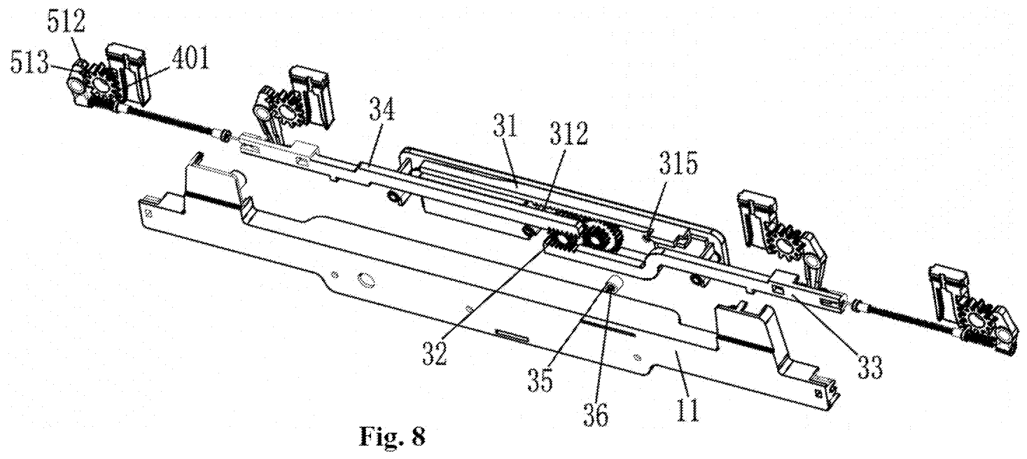

As shown in FIG. 4, FIG. 6, and FIG. 8, the main lock 10 further includes a ball plunger 35 and a ball plunger spring 36. The ball plunger 35 is movably arranged in the main lock housing 1. The ball plunger spring 36 is arranged between the ball plunger 35 and the main lock housing 1, and the ball plunger spring 36 makes the ball plunger 35 abut against the pusher 31. The pusher 31 is provided with a first indication hole 314 and a second indication hole 315 which are matched with the ball plunger 35.

As shown in FIG. 5, the cable 38 includes an outer sleeve 381 and a core rope 382. The outer sleeve 381 is fitted over the core rope 382. One end of the outer sleeve 381 is connected to a second connection base 421 on the second side pressing cover 42, and the other end of the outer sleeve 381 is connected to a first connection base 11l on the lock base 11. One end of the core rope 382 extending out from the outer sleeve 381 is connected to the second button 51, and the other end of the core rope 382 extending out from the outer sleeve 381 is connected to the first rack 33 or the second rack 34.

The embodiments o the present invention further provides a case including a upper case body and a lower case body. The upper case body and the lower case body are locked by the novel multi-stage interlock. The main lock 10 is arranged on the side of the lower case body. The pair of side locks 30 are arranged on the side of the lower case body and at both sides adjacent to the side where the main lock 10 is located. The side opposite to the side where the lower case body and the main lock 10 located is engaged with the upper body by hinges. Two main lock hooks 20 and two side lock hooks 40 are arranged on the upper case body, respectively.

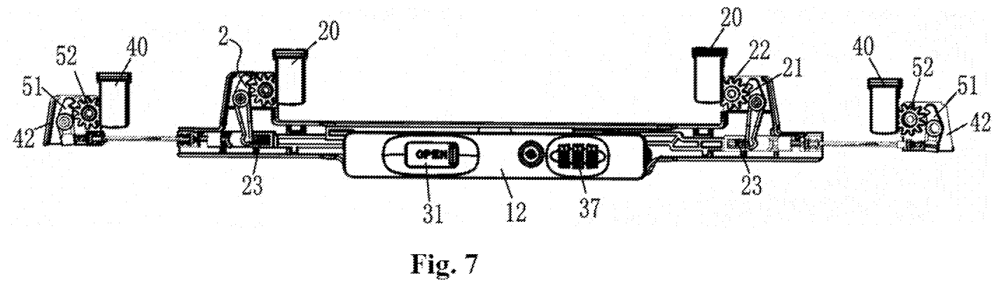

As shown in FIG. 3, FIG. 4, FIG. 6, FIG. 7, and FIG. 8, when the pusher 31 is in a locking state, closing the case, and the main lock hooks 20 and the side lock hook 40 are closed at the same time, the main lock hook 20 drives the corresponding first gear 22 to rotate. The rotation of the first gear 22 forces the first button 21 to overcome the force of the first spring 23. After the main lock hook 20 locks to a next level, the first button 21 is subjected to the force of the first spring 23 and fasten the first gear 22. At the same time, a sound will be generated to let the user know that the main locking hook 20 is anchored. Because the first button 21 is pushed by the first spring 23, the first counterface 212 and the second counterface 213 of the first button 21 stand against the first gear 22, so that the first gear 1 22 cannot be reversed, and the case is in a closed state. When the main lock hook 20 drives the corresponding first gear 22 to rotate, the side lock hooks 40 drive the corresponding second gear 52 to rotate. The rotation of the second gear 52 forces the second button 51 to overcome the force of the second spring 53. When the side lock hooks 40 are pressed to a next level, the second button 51 will be subjected to the force of the second spring 53 and anchor the second gear 52. At the same time, a crash sound will be generated to let the user know that the side lock hook 40 is anchored. Because the second button 51 is pushed by the second spring 53, the third counterface 512 and the fourth counterface 513 of the second button 51 are against the second gear 52, so that the second gear 52 cannot be reversed, and the case is in a closed state. At the same time, the ball plunger 35 is pressed against the pusher 31 by the force of the ball plunger spring 36, so that the pusher 31 will not be pushed arbitrarily. When the user locks the password of the customs lock 37, the pressing piece 371 of the customs lock 37 is pressed down against the tail surface 313 of the pusher 31, so that the lock is in a closed state. When the case needs to be opened, pushing the pusher 31 so that the second indication hole 315 of the pusher 31 fastens the ball plunger 35, and the pusher 31 is in an open state by the force of the ball plunger spring 36. At the same time, the ball plunger 35 is hit by the elastic force of the ball plunger spring 36 and collides with the pusher 31 to generate a crash sound, so that the user can clearly feel the feedback of the sound, and know that the switch is in place. When the pusher 31 is pushed, the pusher 31 drives a reduction gear 32 to rotate, and then the reduction gear 32 drives the first rack 33 and the second rack 34 to move through the other reduction gear 32, making the first rack 33 and the second rack 34 move. The second rack 34 drives the corresponding first button 21 to rotate, so that the first counterface 212 and second counterface 213 of the first button 21 are separated from the first gear 22, so that the first gear 22 can rotate freely, and the main lock hook 20 can be freely disengaged with the first gear 22. At the same time, the second rack 34 of the first rack 33 pulls the cable 38, so that the third counterface 512 and the fourth counterface 513 of the second button 51 are separated from the second gear 52, so that the second gear 52 can rotate freely, and the side lock hook 40 can be freely disengaged from the second gear 52, allowing the case to open.

In addition, the quantity of the appropriate side locks 30 can be selected based on the size of the luggage, to ensure that the product is tightly closed.

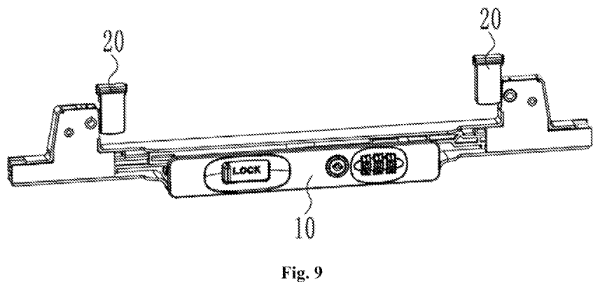

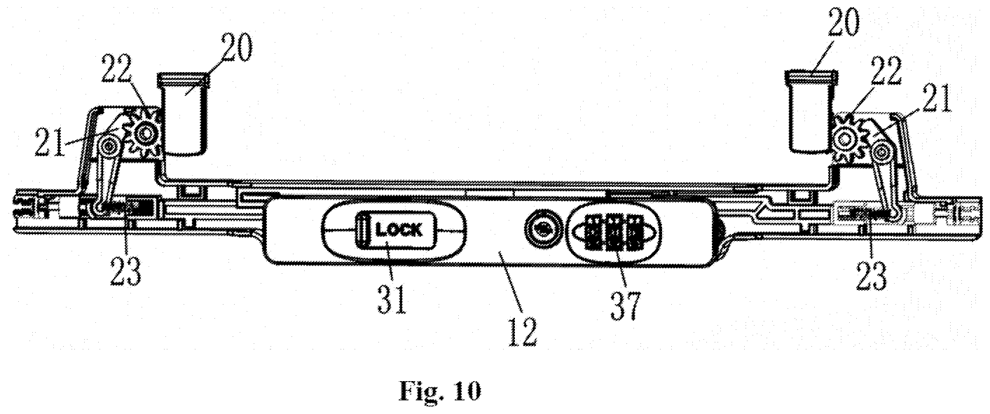

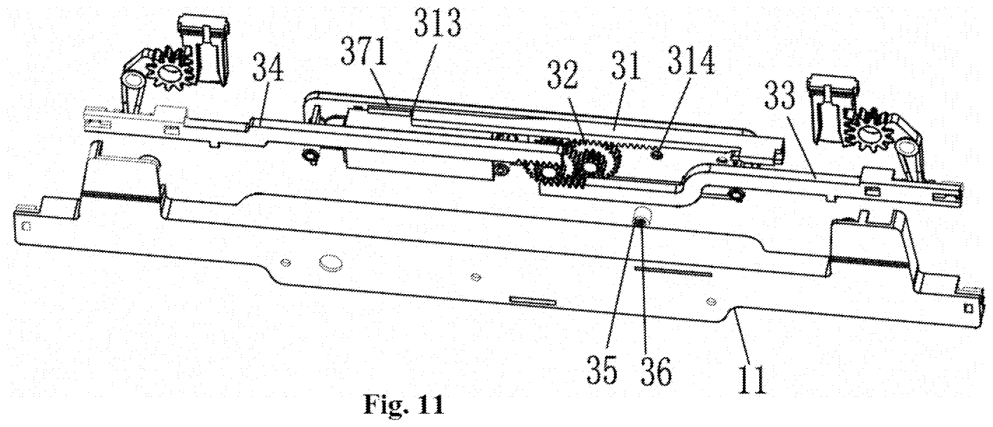

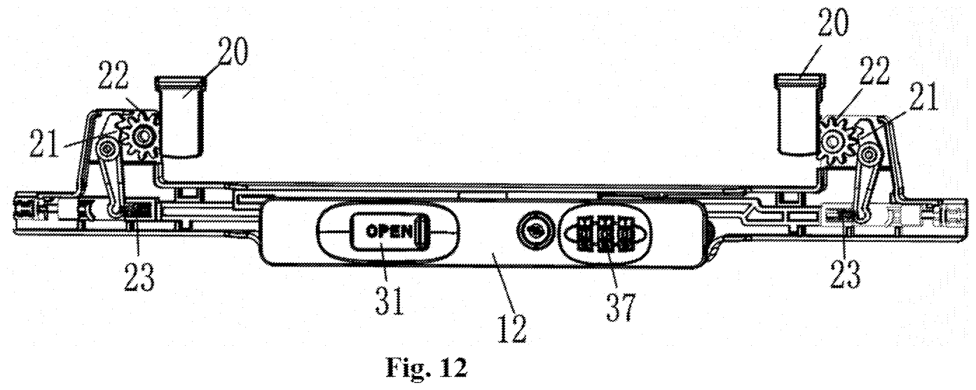

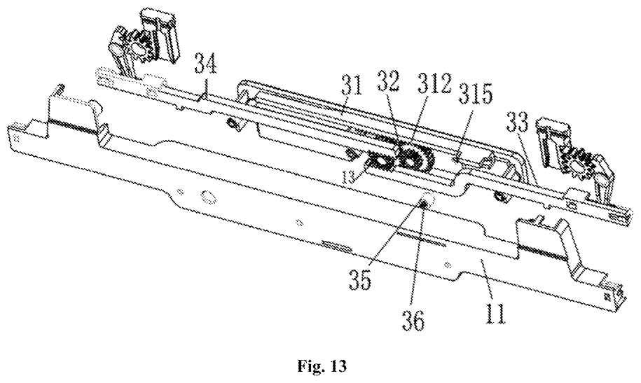

As shown in FIG. 9, FIG. 10, FIG. 11, FIG. 12, FIG. 13, when the case is small, and requires a few of force for closing, the side lock can be removed, realizing product modularization, making production more convenient. The commonality is better and some of die sinking of the product and manufacturing cost can be reduced.

### Second Embodiment

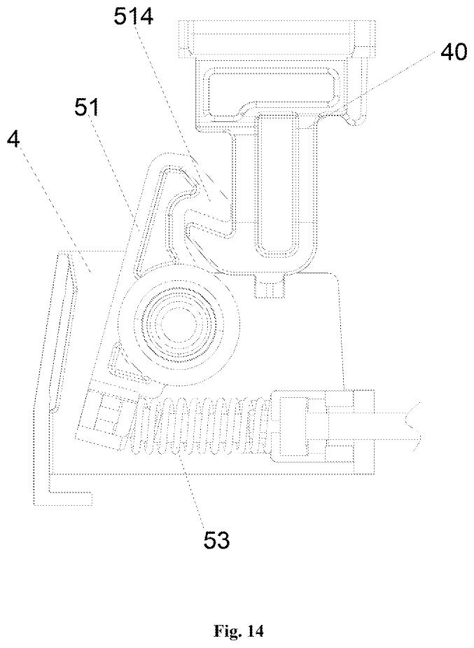

Based on the aforementioned description, the side lock 30 and the side lock hook 40 may be further improved as shown in FIG. 14. The side lock 30 includes a side lock housing 4 and a side lock cylinder assembly 5 arranged within the side lock housing 4. The side lock cylinder assembly 5 includes a second button SI and a second spring 53. The second button 51 is rotatably arranged within the side lock housing 4. One end of the second button 51 is provided with a clamp hook 514 on a side adjacent to the side lock hook 40, and the other end of the second button 51 is connected to the control mechanism 3 through a cable 38. The second spring 53 is arranged between the second button 51 and the side lock housing 4. Under the action of the second spring 53, the clamp hook 514 is capable of being snap-connected to the side lock hook 40.

The above are only preferred embodiments of the present invention, and are not intended to limit the present invention. For those skilled in the art, the present invention may have various modifications and changes. Any modification, equivalent replacement, improvement, etc. made within the spirit and principle of the present invention shall be included within the protection scope of the present invention.

What is claimed is:

1. A novel multi-stage interlock, comprising a main lock (10) and a pair of main lock hooks (20) adapted for the main lock (10); the main lock (10) comprises a main lock housing (1), a control mechanism (3) and a pair of main lock cylinder assemblies (2); the main lock cylinder assemblies (2) and the control mechanism (3) are both arranged in the main lock housing (1); the pair of main lock cylinder assemblies (2) are located on both sides of the control mechanism (3); the control mechanism (3) is capable of controlling the locking and unlocking of all the main lock cylinder assemblies (2) synchronously; the main lock hooks (20) are provided with a plurality of first protruding teeth (201) adapted for the main lock cylinder assemblies (2).

2. The novel multi-stage interlock according to claim 1, wherein the control mechanism (3) comprises a customs lock (37) and a drive assembly; the customs lock (37) is arranged on an inner side of a lock cover (12) of the main lock housing (1); the drive assembly is disposed within the main lock housing (1).

3. The novel multi-stage interlock according to claim 2, wherein the drive assembly includes a pusher (31), at least one reduction gear (32), a first rack (33) and a second rack (34); the pusher (31) is slidably arranged in the main lock housing (1); a push button (311) of the pusher (31) protrudes from a through hole (121) of the lock cover (12) and is slidably matched with the through hole (121); an upper part of the pusher (31) is connected with a top plate part (311); a bottom of the top plate part (311) is provided with a rack portion (312); the rack portion (312) is engaged with a bull gear (321) of the reduction gear (32); the first rack (33) and the second rack (34) are both slidably arranged in the main lock housing (1); the first rack (33) and the second rack (34) are engaged with the pinion gear (322) of the reduction gear (32); an end of the first rack (33) is connected to one of the main lock cylinder assemblies (2); an end of the second rack (34) is connected to the other one of the main lock cylinder assemblies (2).

4. The novel multi-stage interlock according to claim 3, wherein the main lock cylinder assembly (2) includes a first button (21), a first gear (22) and a first spring (23); the first gear (22) is rotatably arranged in the main lock housing (1); the first gear (22) is engageable with the plurality of first protruding teeth (201) on the corresponding main lock hook (20); the first button (21) is rotatably arranged in the main lock housing (1); a first notch (211) is provided on a side of one end of the first button (21) adjacent to the first gear (22); the other end of the first button (21) is movably connected to the first rack (33) or the second rack (34); one end of the first spring (23) is connected to the other end of the first button (21); under the action of the first spring (23), the first notch (211) is capable of being snap-connected to the teeth of the first gear (22).

5. The novel multi-stage interlock according to claim 3, wherein the main lock (10) further comprises a ball plunger (35) and a ball plunger spring (36); the ball plunger (35) is movably arranged in the main lock housing (1); the ball plunger spring (36) is arranged between the ball plunger (35) and the main lock housing (1), and the ball plunger spring (36) biases the ball plunger (35) against the pusher (31); the pusher (31) is provided with a first indication hole (314) and a second indication hole (315) adapted for the ball plunger (35).

6. The novel multi-stage interlock according to claim 3, wherein when the customs lock (37) is locked, a pressing piece (371) of the customs lock (37) is pressed down against a tail surface (313) of the pusher (31).

7. The novel multi-stage interlock according to claim 1, wherein the interlock further comprises a plurality of side locks (30) and side lock hooks (40) adapted for the side locks (30) in one-to-one correspondence; the side lock hook (40) is provided with a plurality of second protruding teeth (401); the control mechanism (3) is capable of simultaneously controlling the locking and unlocking of the plurality of side locks (30) while controlling the locking and unlocking of the main lock cylinder assemblies (2).

8. The novel multi-stage interlock according to claim 6, wherein the side lock (30) comprises a side lock housing (4) and a side lock cylinder assembly (5) disposed in the side lock housing (4); the side lock cylinder assembly (5) comprises a second button (51), a second gear (52) and a second spring (53); the second gear (52) is rotatably arranged in the side lock housing (4), and the second gear (52) is engageable with the plurality of second protruding teeth (401) on the side lock hook (40); the second button (51) is rotatably arranged in the side lock housing (4); one end of the second button (51) is provided with a second notch (511) on one side adjacent to the second gear (52), and the other end of the second button (51) is connected to the control mechanism (3) through a cable (38); the second spring (53) is arranged between the second button (51) and the side lock housing (4); under the action of the second spring (53), the second notch (511) is capable of being snap-connected to the teeth of the second gear (52).

9. The novel multi-stage interlock according to claim 7, further comprising a plurality of side locks (30) and side lock hooks (40) adapted for the side locks in one-to-one correspondence; the control mechanism (3) is capable of synchronously controlling the locking and unlocking of the main lock cylinder assemblies (2), and the locking and unlocking of the plurality of side locks (30); the side lock (30) comprises a side lock housing (4) and side lock cylinder assembly (5) arranged within the side lock housing (4); the side lock cylinder assembly (5) comprises a second button (51) and a second spring (53); the second button (51) is rotatably arranged within the side lock housing (4); one end of the second button (51) is provided with a clamp hook (514) on a side adjacent to the side lock hook (40), and the other end of the second button (51) is connected to the control mechanism (3) through a cable (38); the second spring (53) is arranged between the second button (51) and the side lock housing (4); under the action of the second spring (53), the clamp hook (514) is capable of being snap-connected to the side lock hook (40).

10. The novel multi-stage interlock according to claim 8, wherein the cable (38) includes an outer sleeve (381) and a core rope (382); the outer sleeve (381) is fitted over the core rope (382); one end of the core rope (382) extending out from the outer sleeve (381) is connected to the second button (51), and the other end of the core rope (382) extending out from the outer sleeve (381) is connected to the control mechanism (3) or another second button (51).

11. The novel multi-stage interlock according to claim 9, wherein the cable (38) includes an outer sleeve (381) and a core rope (382); the outer sleeve (381) is fitted over the core rope (382); one end of the core rope (382) extending out from the outer sleeve (381) is connected to the second button (51), and the other end of the core rope (382) extending out from the outer sleeve (381) is connected to the control mechanism (3) or another second button (51).

12. A case, comprising an upper case body, a lower case body, and the above-mentioned novel multi-stage interlock according to claim 1; the upper case body and the lower case body are locked by the novel multi-stage interlock.
